(19) United States
(12) Patent Application Publication
(10) Pub. No.: US 2010/0280833 A1
(43) Pub. Date: Nov. 4, 2010

(54) ENCODING DEVICE, DECODING DEVICE, AND METHOD THEREOF

(75) Inventors: Tomofumi Yamanashi, Kanagawa (JP); Masahiro Oshikiri, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/808,505

(22) PCT Filed: Dec. 26, 2008
(86) PCT No.: PCT/JP2008/003999

§ 371 Date: Jun. 16, 2010

(30) Foreign Application Priority Data
Dec. 27, 2007 (JP) 2007-337239
May 23, 2008 (JP) 2008-135580

(51) Int. Cl. G10L 19/00

(52) U.S. Cl. 704/500; 704/E19.001

(57) ABSTRACT

Provided is an encoding device which can suppress quality degradation of a decoded signal in a band extension for estimating a high range from a low range of a decoded signal. The encoding device includes: a first layer encoding unit (202) which encodes the low-range portion of an input signal to generate first encoded information; a first layer decoding unit (203) which decodes the first encoded information to generate a decoded signal; a second layer encoding unit (206) which estimates a high-range portion of the input signal from the decoded signal so as to generate an estimated signal and generate second encoded information to obtain the estimated signal; a peak feature analysis unit (207) which obtains a difference in a wave adjustment structure between the high-range portion of the input signal and the estimated signal or the low-range portion of the input signal; and an encoding information multiplexing unit (208) which integrates the first encoded information, the second encoded information, and the difference in the wave adjustment structure.

### TECHNICAL FIELD

The present invention relates to an encoding apparatus, decoding apparatus and encoding and decoding methods used in a communication system that encodes and transmits signals.

### BACKGROUND ART

Upon transmitting speech/audio signals (i.e. music signals) in, for example, a packet communication system represented by Internet communication and mobile communication system, compression/coding techniques are often used to improve the efficiency of transmission of speech/audio signals. Also, recently, there is a growing need for techniques of simply encoding speech/audio signals at a low bit rate and encoding speech/audio signals of a wider band.

To meet this need, there is a technique for encoding signals of a wider frequency band at a low bit rate (e.g. see Patent Document 1). According to this technique, the overall bit rate is reduced by dividing an input signal into the lower-band signal and the higher-band signal and by encoding the input signal replacing the spectrum of the higher-band signal with the spectrum of the lower-band signal.

FIG. 1 shows spectral characteristics in the band expansion technique disclosed in Patent Document 1. In FIG. 1, the horizontal axis represents the frequency and the vertical axis represents the spectral amplitude. FIG. 1A shows subband SBᵢ in the higher band of the spectrum of an input signal. FIG. 1B shows subband SBⱼ in the lower band of the spectrum of a decoded signal. Also, Patent Document 1 does not specifically disclose selection criteria as to which band of the lower-band spectrum is used to generate the higher-band spectrum, but discloses a method of searching for the most similar part to the higher-band spectrum from the lower-band spectrum of each frame, as the most common method. Here, assume that, among each subband of the spectrum of the decoded signal, the spectrum of subband SBⱼ has the highest similarity with the spectrum of subband SBᵢ of the input signal. Also, in FIG. 1A, FIG. 1B and FIG. 1C, the peak level of each spectrum is represented using the number of peaks with greater amplitude than threshold A or B.

In FIG. 1C, dashed line 11 represents a spectrum similar to the spectrum shown in FIG. 1A. Further, in FIG. 1C, solid line 12 represents the spectrum of subband SBᵢ acquired by performing band expansion processing using the spectrum shown in FIG. 1B and by further adjusting the energy so as to equal the energy of the spectrum shown in FIG. 1A.

### Patent Document 1: Japanese Translation of PCT Application Laid-Open No. 2001-521648

### DISCLOSURE OF INVENTION

### Problems to be Solved by the Invention

However, the band expansion technique disclosed in Patent Document 1 does not take into account the harmonic structure in the lower-band spectrum of an input signal or the harmonic structure in the lower-band of a decoded spectrum. Therefore, if the harmonic structure is totally different between the higher-band spectrum of an input signal and the lower band of the decoded spectrum in lower layer, peak components are emphasized in the higher band acquired by band expansion, which may degrade sound quality significantly.

For example, as shown in FIG. 1, the peak level varies significantly between the spectrum shown in FIG. 1A and the spectrum shown in FIG. 1B. That is, even if the similarity is high like the spectrum shown in FIG. 1A and the spectrum shown in FIG. 1B, a case is possible where the peak level varies significantly. In this case, if the energy is adjusted using the band expansion technique disclosed in Patent Document 1, as shown in the spectrum shown in FIG. 1C, very high peak 13 occurs which is not present in the spectrum shown in FIG. 1A. Therefore, the quality of the decoded signal degrades significantly.

It is therefore an object of the present invention to provide an encoding apparatus, decoding apparatus and encoding and decoding methods for performing band expansion taking into account the harmonic structure of the lower-band spectrum of an input signal or the harmonic structure of the lower band of a decoded spectrum, thereby suppressing the degradation of quality of decoded signals due to band expansion even in a case where, for example, the harmonic structure varies significantly between the higher-band spectrum of the input signal and the lower band of the decoded spectrum.

### Means for Solving the Problem

The encoding apparatus of the present invention employs a configuration having: a first encoding section that encodes a lower band part of an input signal equal to or lower than a predetermined frequency and generates first encoded information; a decoding section that decodes the first encoded information and generates a decoded signal; a second encoding section that estimates a higher band part of the input signal higher than the frequency from the decoded signal to generate an estimation signal, and generates second encoded information relating to the estimation signal; and an analyzing section that finds a difference of a harmonic structure between the higher band part of the input signal and one of the estimation signal and the lower band part of the input signal.

The decoding apparatus of the present invention employs a configuration having: a receiving section that receives first encoded information, second encoded information and a difference of a harmonic structure, the first encoded information encoding a lower band part of an input signal equal to or lower than a predetermined frequency in an encoding apparatus, the second encoded information being for estimating a higher band part of the input signal higher than the frequency from a first decoded signal acquired by decoding the first encoded information, and the difference of the harmonic structure being provided between the higher band part of the input signal and one of a first estimation signal estimated from the first decoded signal and the lower band part of the input signal; a first decoding section that decodes the first encoded information and provides a second decoded signal; and a second decoding section that generates a second estimation signal by estimating the higher band part of the input signal from the second decoded signal using the second encoded information, generates a third decoded signal by performing peak suppression processing of the second estimation signal when the difference of the harmonic structure is equal to or greater than a threshold, and uses the second estimation signal as is as the third decoded signal when the difference of the harmonic structure is less than the threshold.

The encoding method of the present invention includes the steps of: encoding a lower band part of an input signal equal to or lower than a predetermined frequency and generating first encoded information; decoding the first encoded information and generating a decoded signal; estimating a higher band part of the input signal greater than the frequency from the decoded signal to generate an estimation signal, and generating second encoded information relating to the estimation signal; and finding a difference of a harmonic structure between the higher band part of the input signal and one of the estimation signal and the lower band part of the input signal.

The decoding method of the present invention includes the steps of: receiving first encoded information, second encoded information and a difference of a harmonic structure, the first encoded information encoding a lower band part of an input signal equal to or lower than a predetermined frequency in an encoding apparatus, the second encoded information being for estimating a higher band part of the input signal higher than the frequency from a first decoded signal acquired by decoding the first encoded information, and the difference of the harmonic structure being provided between the higher band part of the input signal and one of a first estimation signal estimated from the first decoded signal and the lower band part of the input signal; decoding the first encoded information and generating a second decoded signal; and generating a second estimation signal by estimating the higher band part of the input signal from the second decoded signal using the second encoded information, generating a third decoded signal by performing peak suppression processing of the second estimation signal when the difference of the harmonic structure is equal to or greater than a threshold, and using the second estimation signal as is as the third decoded signal when the difference of the harmonic structure is less than the threshold.

### ADVANTAGEOUS EFFECT OF THE INVENTION

According to the present invention, it is possible to suppress a peak which is not present in an input signal and which may occur in an estimation signal acquired by band expansion, and suppress the degradation of quality of decoded signals.

### BRIEF DESCRIPTION OF DRAWINGS

FIG. 1 shows spectral characteristics in a conventional band expansion technique;

FIG. 2 is a block diagram showing the configuration of a communication system including an encoding apparatus and decoding apparatus according to Embodiment 1 of the present invention;

FIG. 3 is a block diagram showing the main components inside an encoding apparatus shown in FIG. 2;

FIG. 4 is a block diagram showing the main components inside a second layer encoding section shown in FIG. 3;

FIG. 5 illustrates filtering processing in a filtering section shown in FIG. 4 in detail;

FIG. 6 is a flowchart showing the steps in the process of analyzing a peak level in a peak level analyzing section shown in FIG. 4;

FIG. 7 is a flowchart showing the steps in the process of searching for optimal pitch coefficient T′ in a searching section shown in FIG. 4;

FIG. 8 is a block diagram showing the main components inside a decoding apparatus shown in FIG. 2;

FIG. 9 is a block diagram showing the main components inside a second layer decoding section shown in FIG. 8;

FIG. 10 shows a result of performing peak suppression processing in a peak suppression processing section shown in FIG. 9;

FIG. 11 is a block diagram showing the main components inside a first layer encoding section shown in FIG. 3;

FIG. 12 is a block diagram showing the main components inside a first layer decoding section shown in FIG. 3;

FIG. 13 is a block diagram showing the main components inside an encoding apparatus according to Embodiment 2 of the present invention;

FIG. 14 is a block diagram showing the main components inside a second layer encoding section shown in FIG. 13;

FIG. 15 is a flowchart showing the steps in the process of searching for optimal pitch coefficient T′ in a searching section shown in FIG. 14;

FIG. 16 illustrates an estimated spectrum selected in a searching section shown in FIG. 14;

FIG. 17 is a block diagram showing the main components inside a decoding apparatus according to Embodiment 2 of the present invention; and

FIG. 18 is a block diagram showing the main components inside a second layer encoding section shown in FIG. 17.

### BEST MODE FOR CARRYING OUT THE INVENTION

An example of an outline of the present invention is that, in a case where the difference in the harmonic structure between the higher band of an input signal and one of the lower-band spectrum of a decoded signal and the lower band of the input signal is taken into account, if this difference is equal to or greater than a predetermined level, the decoding side performs peak suppression processing. By this means, it is possible to suppress a peak that is not present in an input signal and that may occur in an estimation signal acquired by band expansion, and suppress the degradation of quality of a decoded signal.

Embodiments of the present invention will be explained below in detail with reference to the accompanying drawings. Also, the encoding apparatus and decoding apparatus according to the present invention will be explained using a speech encoding apparatus and speech decoding apparatus as an example.

### Embodiment 1

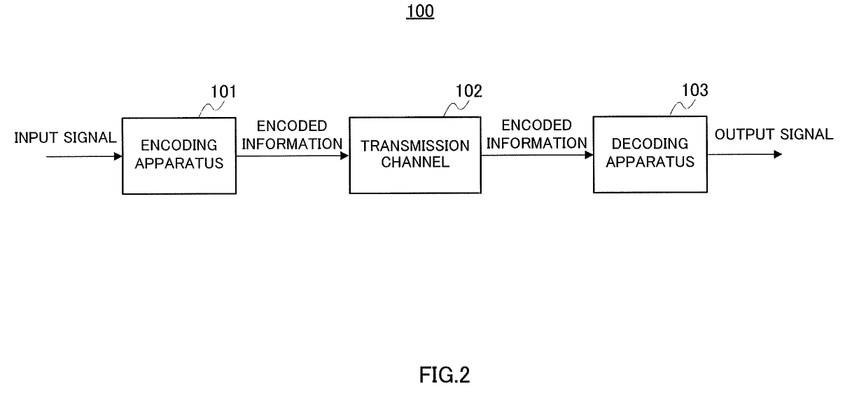

FIG. 2 is a block diagram showing the configuration of a communication system including an encoding apparatus and decoding apparatus according to Embodiment 1 of the present invention. In FIG. 2, communication system 100 provides encoding apparatus 101 and decoding apparatus 103, which can communicate with each other via transmission channel 102.

Encoding apparatus 101 divides an input signal every N samples (where N is a natural number) and performs coding per frame comprised of N samples. In this case, an input signal to be encoded is represented by xₙ (n=0, . . . , N−1). Here, n represents the (n+1)-th signal element of the input signal divided every N samples. Encoded input information (i.e. encoded information) is transmitted to decoding apparatus 103 via transmission channel 102.

Decoding apparatus 103 receives and decodes the encoded information transmitted from encoding apparatus 101 via transmission channel 102, and provides an output signal.

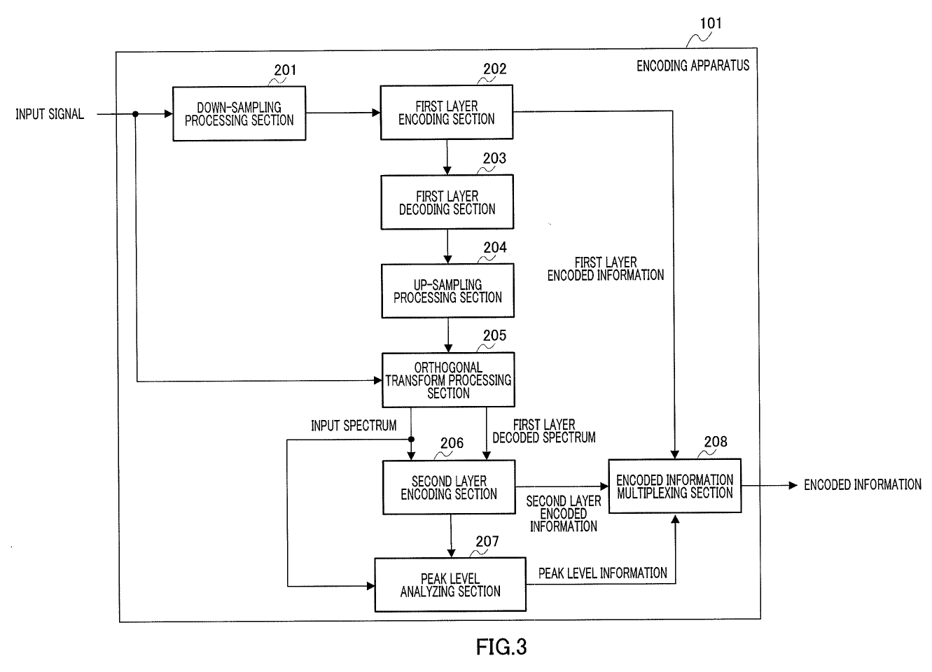

FIG. 3 is a block diagram showing the main components inside encoding apparatus 101 shown in FIG. 2. When the sampling frequency of an input signal is SRᵢₙₚᵤₜ, down-sampling processing section 201 down-samples the sampling frequency of the input signal from SRᵢₙₚᵤₜ to SR_{base} (SR_{base}<SRᵢₙₚᵤₜ), and outputs the down-sampled input signal to first layer encoding section 202 as a down-sampled input signal.

First layer encoding section 202 encodes the down-sampled input signal received as input from down-sampling processing section 201 using, for example, a CELP (Code Excited Linear Prediction) type speech encoding method, and generates first layer encoded information. Further, first layer encoding section 202 outputs the generated first layer encoded information to first layer decoding section 203 and encoded information multiplexing section 208.

First layer decoding section 203 decodes the first layer encoded information received as input from first layer encoding section 202 using, for example, a CELP type speech decoding method, to generate a first layer decoded signal, and outputs the generated first layer decoded signal to up-sampling processing section 204.

Up-sampling processing section 204 up-samples the sampling frequency of the first layer decoded signal received as input from first layer decoding section 203 from SR_{base} to SRᵢₙₚᵤₜ, and outputs the up-sampled first layer decoded signal to orthogonal transform processing section 205 as an up-sampled first layer decoded signal.

Orthogonal transform processing section 205 incorporates buffers buf 1ₙ and buf 2ₙ (n=0, . . . , N−1) and applies the modified discrete cosine transform (“MDCT”) to input signal xₙ and up-sampled first layer decoded signal yₙ received as input from up-sampling processing section 204.

Next, as for the orthogonal transform processing in orthogonal transform processing section 205, the calculation steps and data output to the internal buffers will be explained.

First, orthogonal transform processing section 205 initializes the buffers buf 1ₙ and buf 2ₙ using 0 as the initial value according to equation 1 and equation 2.

[1]

buf1ₙ=0 (n=0, . . . , N−1) (Equation 1)

buf2ₙ=0 (n=0, . . . , N−1) (Equation 2)

Next, orthogonal transform processing section 205 applies the MDCT to input signal xₙ and up-sampled first layer decoded signal yₙ according to following equations 3 and 4, and calculates MDCT coefficients S2(k) of the input signal (hereinafter “input spectrum”) and MDCT coefficients S1(k) of up-sampled first layer decoded signal yₙ (hereinafter “first layer decoded spectrum”).

$$\begin{matrix}( Equation 3 ) & \\ S 2 ( k ) = \frac{2}{N} {\sum }_{n = 0}^{2 N - 1} {x}_{n}^{′} cos [ \frac{( 2 n + 1 + N ) ( 2 k + 1 ) π}{4 N} ] \\ ( k = 0 , … , N - 1 ) & [ 3 ] \\ ( Equation 4 ) & \\ S 1 ( k ) = \frac{2}{N} {\sum }_{n = 0}^{2 N - 1} {y}_{n}^{′} cos [ \frac{( 2 n + 1 + N ) ( 2 k + 1 ) π}{4 N} ] \\ ( k = 0 , … , N - 1 ) & [ 4 ]\end{matrix}$$

Here, k is the index of each sample in a frame. Orthogonal transform processing section 205 calculates xₙ′, which is a vector combining input signal xₙ and buffer buf 1ₙ, according to following equation 5. Further, orthogonal transform processing section 205 calculates yₙ′, which is a vector combining up-sampled first layer decoded signal yₙ and buffer buf 2ₙ, according to following equation 6.

$$\begin{matrix}( Equation 5 ) & \\ {x}_{n}^{′} = \{ \begin{matrix}buf {1}_{n} & ( n = 0 , … N - 1 ) \\ {x}_{n - N} & ( n = N , … 2 N - 1 )\end{matrix} & [ 5 ] \\ ( Equation 6 ) & \\ {y}_{n}^{′} = \{ \begin{matrix}buf {2}_{n} & ( n = 0 , … N - 1 ) \\ {y}_{n - N} & ( n = N , … 2 N - 1 )\end{matrix} & [ 6 ]\end{matrix}$$

Next, orthogonal transform processing section 205 updates buffers buf 1ₙ and buf 2ₙ according to equation 7 and equation 8.

[7]

buf1ₙ=xₙ (n=0, . . . , N−1) (Equation 7)

[8]

buf2ₙ=yₙ (n=0, . . . , N−1) (Equation 8)

Further, orthogonal transform processing section 205 outputs input spectrum S2(k) and first layer decoded spectrum S1(k) to second layer encoding section 207. Further, orthogonal transform processing section 205 outputs input spectrum S2(k) to peak level analyzing section 207.

Second layer encoding section 206 generates second layer encoded information using input spectrum S2(k) and first layer decoded spectrum S1(k) received as input from orthogonal transform processing section 205, and outputs the generated second layer encoded information to encoded information multiplexing section 208. Further, second layer encoding section 206 estimates the input spectrum and outputs estimated spectrum S2′(k) to peak level analyzing section 207. Second layer encoding section 206 will be described later in detail.

Peak level analyzing section 207 analyzes the peak levels of input spectrum S2(k) received as input from orthogonal transform processing section 205 and estimated spectrum S2′(k) received as input from second layer encoding section 206, and outputs peak level information showing this analysis result to encoded information multiplexing section 208. Also, peak level analysis process in peak level analyzing section 207 will be described later in detail.

Encoded information multiplexing section 208 integrates the first layer encoded information received as input from first layer encoding section 202, the second layer encoded information received as input from second layer encoding section 206 and the peak level information received as input from peak level analyzing section 207, adds, if necessary, a transmission error code and so on, to the integrated encoded information, and outputs the result to transmission channel 102 as encoded information.

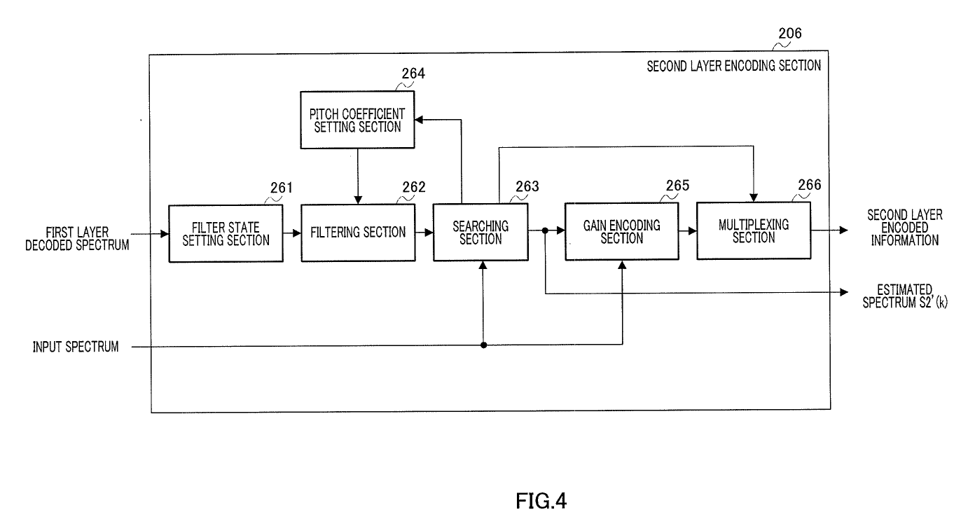

Next, the main components inside second layer encoding section 206 shown in FIG. 3 will be explained using FIG. 4.

Second layer encoding section 206 is provided with filter state setting section 261, filtering section 262, searching section 263, pitch coefficient setting section 264, gain encoding section 265 and multiplexing section 266. These components perform the following operations.

Filter state setting section 261 sets first layer decoded spectrum S1(k) [0≦k<FL] received as input from orthogonal transform processing section 205, as a filter state used in filtering section 262. As the internal state of the filter (i.e. filter state), first layer decoded spectrum S1(k) is stored in the band 0≦k<FL of spectrum S(k) in the entire frequency band 0≦k<FH in filtering section 262.

Filtering section 262 has a multi-tap pitch filter (i.e. a filter having more than one tap), filters the first layer decoded spectrum based on the filter state set in filter state setting section 261 and pitch coefficients received as input from pitch coefficient setting section 264, and calculates estimated value S2′(k) [FL≦k<FH] of the input spectrum (hereinafter “estimated spectrum”). Further, filtering section 262 outputs estimated spectrum S2′(k) to searching section 263. The filtering processing in filtering section 262 will be described later in detail.

Searching section 263 calculates the similarity between the higher band FL≦k<FH of input spectrum S2(k) received as input from orthogonal transform processing section 205 and estimated spectrum S2′(k) received as input from filtering section 262. The similarity is calculated by, for example, correlation calculations. Processing in filtering section 262, processing in searching section 263 and processing in pitch coefficient setting section 264 form a closed loop. In this closed loop, searching section 263 calculates the similarity for each pitch coefficient by variously changing the pitch coefficient T received as input from pitch coefficient setting section 264 to filtering section 262. Of these calculated similarities, searching section 263 outputs the pitch coefficient to maximize the similarity, that is, optimal pitch coefficient T′ (within a range from Tmin to Tmax), to multiplexing section 266. Further, searching section 263 outputs estimated spectrum S2′(k) for this optimal pitch coefficient T′ to gain encoding section 265 and peak level analyzing section 207. Also, searching process of optimal pitch coefficient T′ in searching section 263 will be described later in detail.

Pitch coefficient setting section 264 changes pitch coefficient T little by little in the search range from Tₘᵢₙ to Tₘₐₓ under the control of searching section 263, and sequentially outputs pitch coefficient T to filtering section 262.

Gain encoding section 265 calculates gain information of the higher band FL≦k<FH of input spectrum S2(k) received as input from orthogonal transform processing section 205. To be more specific, gain encoding section 265 divides the frequency band FL≦k<FH into J subbands and calculates spectral power per subband of input spectrum S2(k). In this case, spectral power B(j) of the j-th subband is represented by following equation 9.

$$\begin{matrix}( Equation 9 ) & \\ B ( j ) = {\sum }_{k = BL ( j )}^{BH ( j )} S 2 {( k )}^{2} & [ 9 ]\end{matrix}$$

In equation 9, BL(j) represents the lowest frequency in the j-th subband and BH(j) represents the highest frequency in the j-th subband. Further, similarly, gain encoding section 265 calculates spectral power B′(j) per subband of estimated spectrum S2′(k) according to following equation 10. Next, gain encoding section 265 calculates variation V(j) per subband of an estimated spectrum for input spectrum S2(k), according to following equation 11.

$$\begin{matrix}( Equation 10 ) & \\ {B}^{′} ( j ) = {\sum }_{k = BL ( j )}^{BH ( j )} S {2}^{′} {( k )}^{2} & [ 11 ] \\ V ( j ) = \sqrt{\frac{B ( j )}{{B}^{′} ( j )}} & ( Equation 11 )\end{matrix}$$

Further, gain encoding section 265 encodes variation V(j) and outputs the index matching encoded variation V_{q}(j) to multiplexing section 266.

Multiplexing section 266 multiplexes optimal pitch coefficient T′ received as input from searching section 263 and the index of variation V(j) received as input from gain encoding section 265, and outputs the result to encoded information multiplexing section 208 as second layer encoded information. Here, it is equally possible to directly input T′ and the index of V(j) in encoded information multiplexing section 208 and multiplex them with first layer encoded information in encoded information multiplexing section 208.

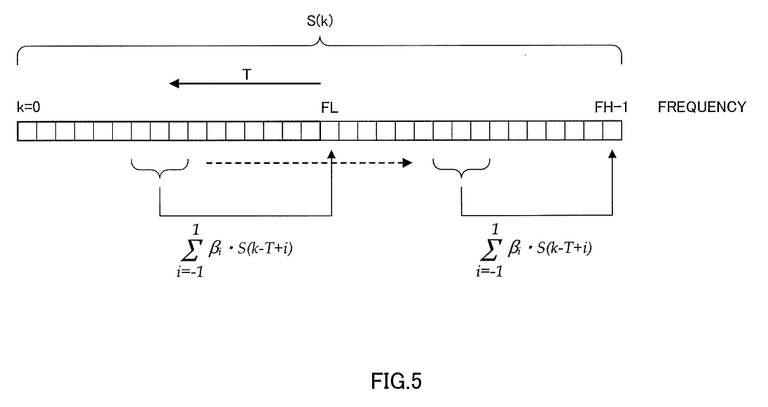

Next, filtering processing in filtering section 262 will be explained in detail using FIG. 5.

Filtering section 262 generates the spectrum of the band FL≦k<FH using pitch coefficient T received as input from pitch coefficient setting section 264. The transfer function in filtering section 262 is represented by following equation 12.

$$\begin{matrix}( Equation 12 ) & \\ P ( z ) = \frac{1}{1 - {\sum }_{i = - M}^{M} {β}_{i} {z}^{- T + i}} & [ 12 ]\end{matrix}$$

In equation 12, T represents the pitch coefficients given from pitch coefficient setting section 264, and βᵢ represents the filter coefficients stored inside in advance. For example, when the number of taps is three, the filter coefficient candidates are (β₋₁, β₀, β₁)=(0.1, 0.8, 0.2). In addition, the values (β₋₁, β₀, β₁)=(0.2, 0.6, 0.2) or (0.3, 0.4, 0.3) are possible. Also, M is 1 in equation 12. Further, M represents the index related to the number of taps.

The band 0≦k<FL in spectrum S(k) of the entire frequency band in filtering section 262 stores first layer decoded spectrum S1(k) as the internal state of the filter (i.e. filter state).

The band FL≦k<FH of S(k) stores estimated spectrum S2′(k) by filtering processing of the following steps. That is, spectrum S(k−T) of a frequency that is lower than k by T, is basically assigned to S2′(k). Here, to improve the smoothing level of the spectrum, in fact, it is necessary to assign the sum of spectrums to S2′(k), where these spectrums are acquired by assigning all i's to spectrum βᵢ·S(k−T+i) multiplying predetermined filter coefficient βᵢ by spectrum S(k−T+i), and where spectrum βᵢ·S(k−T+i) is a nearby spectrum separated by i from spectrum S(k−T). This processing is represented by following equation 13.

$$\begin{matrix}( Equation 13 ) & \\ S {2}^{′} ( k ) = {\sum }_{i = - 1}^{1} {β}_{i} \cdot S 2 {( k - T + i )}^{2} & [ 13 ]\end{matrix}$$

By performing the above calculation by changing frequency k in the range FL≦k<FH in order from the lowest frequency FL, estimated spectrum S2′(k) in FL≦k<FH is calculated.

The above filtering processing is performed by zero-clearing S(k) in the range FL≦k<FH every time pitch coefficient T is given from pitch coefficient setting section 264. That is, S(k) is calculated and outputted to searching section 263 every time pitch coefficient T changes.

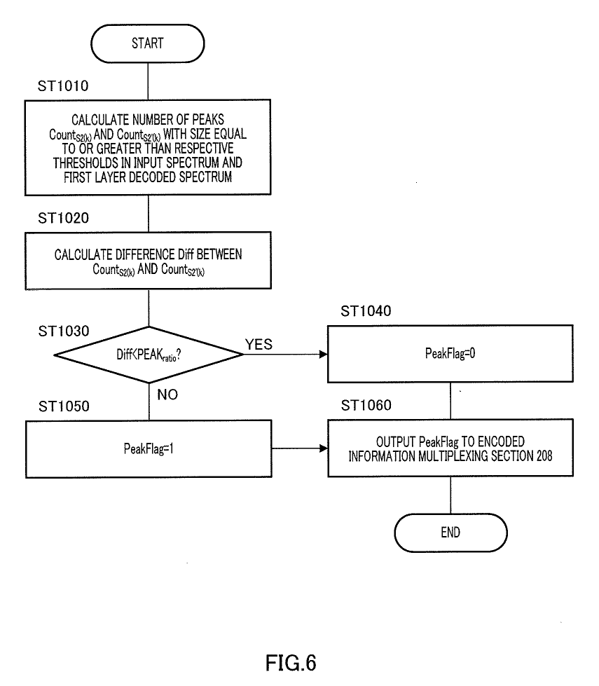

Next, peak level analyzing process in peak level analyzing section 207 will be explained in detail using the flowchart shown in FIG. 6.

First, in step (hereinafter referred to as “ST”) 1010, according to following equations 14 and 15, peak level analyzing section 207 calculates the number of peaks Count_{S2(k)} and Count_{S2′(k)} with a level equal to or greater than respective thresholds in input spectrum S2(k) received as input from orthogonal transform processing section 205 and estimated spectrum S2′(k) received as input from searching section 263.

$$\begin{matrix}( Equation 14 ) & \\ {Count}_{S 2 ( k )} = \sum p \\ p = \{ \begin{matrix}1 & ( \begin{matrix}if S 2 ( k ) \geq {PEAK}_{c ount\_S 2 ( k )} and \\ S 2 ( k - 1 ) < {PEAK}_{count\_S 2 ( k )}\end{matrix} ) \\ 0 & ( else )\end{matrix} \\ where & [ 14 ] \\ ( Equation 15 ) & \\ {Count}_{S {2}^{′} ( k )} = \sum p \\ p = \{ \begin{matrix}1 & ( \begin{matrix}if S {2}^{′} ( k ) \geq {PEAK}_{count\_S {2}^{′} ( k )} and \\ S {2}^{′} ( k ) < {PEAK}_{count\_S {2}^{′} ( k )}\end{matrix} ) \\ 0 & ( else )\end{matrix} \\ where & [ 15 ]\end{matrix}$$

In equations 14 and 15, of k's having values equal to or greater than a threshold, assume that only the first k of consecutive k's is counted and the rest of the consecutive k's are not counted. That is, upon counting peaks, adjacent samples are excluded. In other words, if peaks extend transversally, these peaks are not counted every sample, and peaks of adjacent samples are counted as one. By this means, the number of peaks is determined. Here, PEAK_{count}_{_{—}}_{S2(k)} and PEAK_{count}_{_{—}}_{S2′(k)} are set for input spectrum S2(k) and estimated spectrum S2′(k), respectively, as a threshold to use upon calculating the number of peaks. These thresholds may be a predetermined value or may be calculated from the energy of each spectrum on a per frame basis.

Next, in ST 1020, peak level analyzing section 207 calculates absolute value Diff of the difference between Count_{S2(k)} peak count and peak count Count_{S2′(k)} in each spectrum, according to following equation 16.

[16]

Diff=|Count_{S2(k)}−Count_{S2(k)}| (Equation 16)

Next, in ST 1030 to ST 1050, peak level analyzing section 207 calculates peak level information PeakFlag using Diff, according to following equation 17.

$$\begin{matrix}( Equation 17 ) & \\ PeakFlag = \{ \begin{matrix}0 & ( if Diff < {PEAK}_{Diff} ) \\ 1 & ( else )\end{matrix} & [ 17 ]\end{matrix}$$

To be more specific, in ST 1030, peak level analyzing section 207 decides whether or not Diff is less than threshold PEAK_{Diff}. If it is decided that Diff is less than threshold PEAK_{Diff} in ST 1030 (“YES” in ST 1030), peak level analyzing section 207 sets peak level information PeakFlag to “0” in ST 1040. By contrast, if it is decided that Diff is equal to or greater than threshold PEAK_{Diff} in ST 1030 (“NO” in ST 1030), peak level analyzing section 207 sets peak level information PeakFlag to “1” in ST 1050. This peak level information PeakFlag relates to the harmonic structure, and indicates “0” when there is no significant difference of peak levels between input spectrum S2(k) and estimated spectrum S2′(k) or indicates “1” when there is a large difference of peak levels between these spectrums. Here, if the value of peak level information PeakFlag is 0, the decoding apparatus side does not perform peak suppression processing of the estimated spectrum. By contrast, if the value of peak level information PeakFlag is 1, the decoding apparatus side performs peak suppression processing of the estimated spectrum, thereby suppressing emphasized peaks and improving the quality of decoded signals.

Next, in ST 1060, peak level analyzing section 207 outputs peak level information PeakFlag to encoded information multiplexing section 208.

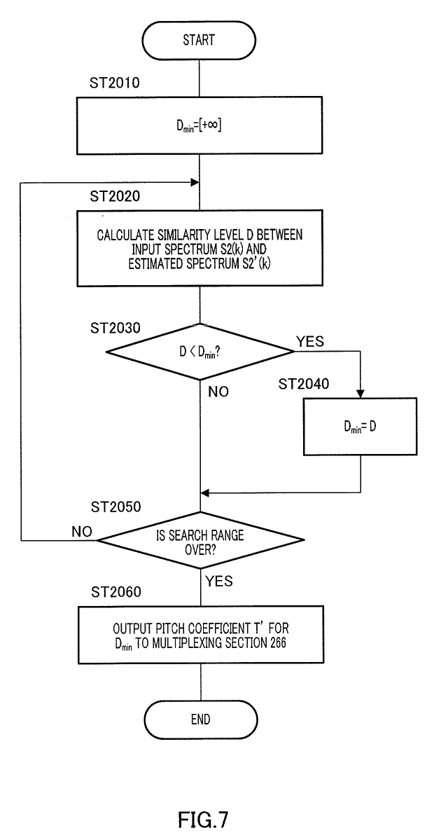

FIG. 7 is a flowchart showing the steps in the process of searching for optimal pitch coefficient T′ in searching section 263.

First, searching section 263 initializes minimum similarity Dₘᵢₙ, which is a variable value for storing the minimum similarity value, to [+∞] (ST 2010). Next, according to following equation 18, searching section 263 calculates similarity D between the higher band FL≦k<FH of input spectrum S2(k) at a given pitch coefficient and estimated spectrum S2′(k) (ST 2020).

$$\begin{matrix}( Equation 18 ) & \\ D = {\sum }_{k = 0}^{{M}^{′}} S 2 ( k ) \cdot S 2 ( k ) - \frac{{( {\sum }_{k = 0}^{{M}^{′}} S 2 ( k ) \cdot S {2}^{′} ( k ) )}^{2}}{{\sum }_{k = 0}^{{M}^{′}} S {2}^{′} ( k ) \cdot S {2}^{′} ( k )} & [ 18 ]\end{matrix}$$

In equation 18, M′ represents the number of samples upon calculating similarity D, and adopts an arbitrary value equal to or less than the sample length FH−FL+1 in the higher band.

Also, as described above, an estimated spectrum generated in filtering section 262 is the spectrum acquired by filtering the first layer decoded spectrum. Therefore, the similarity between the higher band FL≦k<FH of input spectrum S2(k) and estimated spectrum S2′(k) calculated in searching section 263 also shows the similarity between the higher band FL≦k<FH of input spectrum S2(k) and the first layer decoded spectrum.

Next, searching section 263 decides whether or not calculated similarity D is less than minimum similarity Dₘᵢₙ (ST 2030). If the similarity calculated in ST 2020 is less than minimum similarity Dₘᵢₙ (“YES” in ST 2030), searching section 263 assigns similarity D to minimum similarity Dₘᵢₙ (ST 2040). By contrast, if the similarity calculated in ST 2020 is equal to or greater than minimum similarity Dₘᵢₙ (“NO” in ST 2030), searching section 263 decides whether or not the search range is over (ST 2050). That is, with respect to all pitch coefficients in the search range, searching section 263 decides whether or not the similarity is calculated according to above equation 18 in ST 2020. If the search range is not over (“NO” in ST 2050), the flow returns to ST 2020 again in searching section 263. Further, searching section 263 calculates the similarity according to equation 18, with respect to a different pitch coefficient from the pitch coefficient used when the similarity was previously calculated according to equation 18 in the step of ST 2020. By contrast, if the search range is over (“YES” in ST 2050), searching section 263 outputs pitch coefficient T associated with minimum similarity Dₘᵢₙ to multiplexing section 266 as optimal pitch coefficient T′ (ST 2060).

Next, decoding apparatus 103 shown in FIG. 2 will be explained.

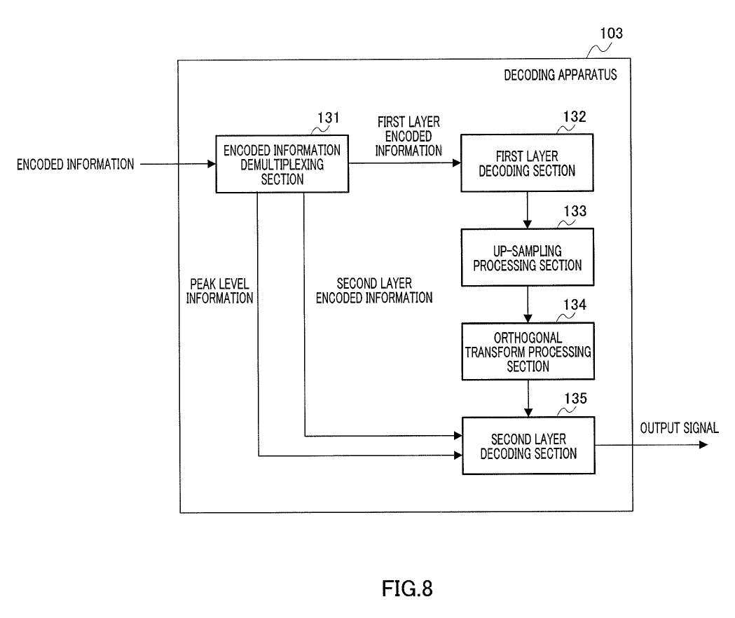

FIG. 8 is a block diagram showing the main components inside decoding apparatus 103.

In FIG. 8, encoded information demultiplexing section 131 separates first layer encoded information, second layer encoded information and peak level information PeakFlag from input encoded information, outputs the first layer encoded information to first layer decoding section 132 and outputs the second layer encoded information and peak level information PeakFlag to second layer decoding section 135.

First layer decoding section 132 decodes the first layer encoded information received as input from encoded information demultiplexing section 131, and outputs a generated first layer decoded signal to up-sampling processing section 133. Here, the configuration and operations of first layer decoding section 132 are the same as in first layer decoding section 203 shown in FIG. 3, and therefore specific explanations will be omitted.

Up-sampling processing section 133 performs processing of up-sampling the sampling frequency of the first layer decoded signal received as input from first layer decoding section 132 from SR_{base} to SRᵢₙₚᵤₜ, and outputs a resulting up-sampled first layer decoded signal to orthogonal transform processing section 134.

Orthogonal transform processing section 134 applies orthogonal transform processing (i.e. MDCT) to the up-sampled first layer decoded signal received as input from up-sampling processing section 133, and outputs MDCT coefficient S1(k) of the resulting up-sampled first layer decoded signal (hereinafter “first layer decoded spectrum”) to second layer decoding section 135. Here, the configuration and operations of orthogonal transform processing section 134 are the same as in orthogonal transform processing section 205 shown in FIG. 3, and therefore specific explanation will be omitted.

Second layer decoding section 135 generates a second layer decoded signal including higher-band components, from first layer decoded spectrum S1(k) received as input from orthogonal transform processing section 134 and from second layer encoded information and peak level information received as input from encoded information demultiplexing section 131, and outputs the second layer decoded signal as an output signal.

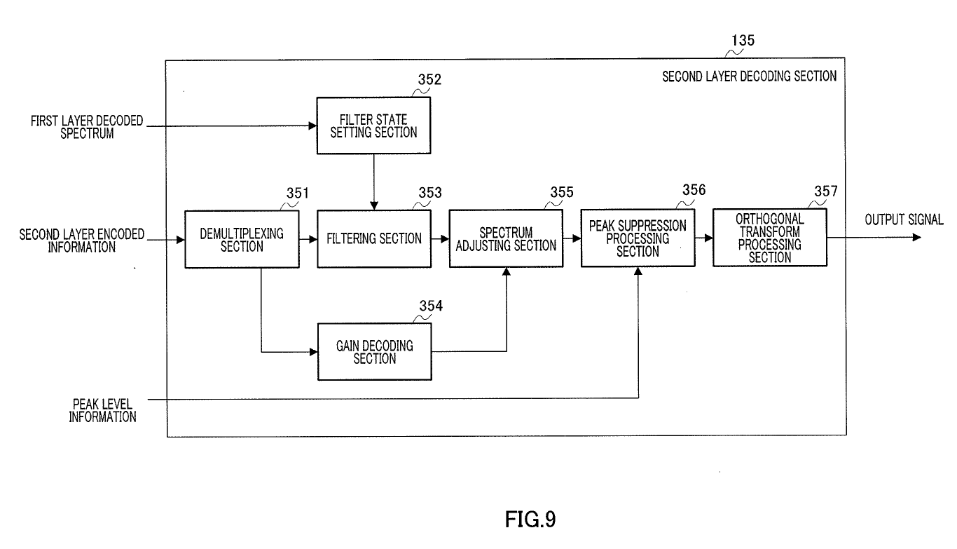

FIG. 9 is a block diagram showing the main components inside second layer decoding section 135 shown in FIG. 8.

Demultiplexing section 351 demultiplxes second layer encoded information received as input from encoded information demultiplexing section 131 into optimal pitch coefficient T′ and the index of encoded variation V_{q}(j), where optimal pitch coefficient T′ is information related to filtering and encoded variation V_{q}(j) is information related to gains. Further, demultiplexing section 351 outputs optimal pitch coefficient T′ to filtering section 353 and outputs the index of encoded variation V_{q}(j) to gain decoding section 354. Here, if T′ and the index of encoded variation V_{q}(j) have been separated in information demultiplexing section 131, it is not necessary to provide demultiplexing section 351.

Filter state setting section 352 sets first layer decoded spectrum S1(k) [0≦k<FL] received as input from orthogonal transform processing section 134 to the filter state used in filtering section 353. Here, when a spectrum of the entire frequency band 0≦k<FH in filtering section 353 is referred to as “S(k)” for ease of explanation, first layer decoded spectrum S1(k) is stored in the band 0≦k<FL of S(k) as the internal state (filter state) of the filter. Here, the configuration and operations of filter state setting section 352 are the same as in filter state setting section 261 shown in FIG. 4, and therefore explanation will be omitted.

Filtering section 353 has a multi-tap pitch filter (i.e. a filter having more than one tap). Further, filtering section 353 filters first layer decoded spectrum S1(k) based on the filter state set in filter state setting section 352, optimal pitch coefficient T′ received as input from demultiplexing section 351 and filter coefficients stored inside in advance, and calculates estimated spectrum S2′(k) of input spectrum S2(k) as shown in above equation 13. Even in filtering section 353, the filter function shown in above equation 12 is used.

Gain decoding section 354 decodes the index of encoded variation V_{q}(j) received as input from demultiplexing section 351 and calculates variation V_{q}(j) representing the quantized value of variation V(j).

According to following equation 19, spectrum adjusting section 355 multiplies estimated spectrum S2′(k) received as input from filtering section 353 by variation V_{q}(j) per subband received as input from gain decoding section 354. By this means, spectrum adjusting section 355 adjusts the spectral shape in the frequency band FL≦k<FH of estimated spectrum S2′(k), and generates and outputs decoded spectrum S3(k) to peak suppression processing section 356.

[19]

S3(k)=S2′(k)·V_{q}(j)(BL(j)≦k≦BH(j), for all j) (Equation 19)

Here, the lower band 0≦k<FL of decoded spectrum S3(k) is comprised of first layer decoded spectrum S1(k), and the higher band FL≦k<FH of decoded spectrum S3(k) is comprised of estimated spectrum S2′(k) with the adjusted spectral shape.

Peak suppression processing section 356 switches between applying and not applying peak suppression processing of decoded spectrum S3(k) received as input from spectrum adjusting section 355, according to the value of peak level information PeakFlag received as input from encoded information demultiplexing section 131. To be more specific, if the value of input peak level information PeakFlag is 0, peak suppression processing section 356 does not apply peak suppression processing to decoded spectrum S3(k) and instead outputs decoded spectrum S3(k) as is to orthogonal transform processing section 357 as second layer decoded spectrum S4(k). Also, if the value of input peak level information PeakFlag is 1, peak suppression processing section 356 filters decoded spectrum S3(k) as shown in following equation 20 to apply smoothing (blunting) to the spectrum, and outputs resulting second layer decoded spectrum S4(k) to orthogonal transform processing section 357.

$$\begin{matrix}( Equation 20 ) & \\ S 4 ( k ) = {\sum }_{i = - 1}^{1} {β}_{i} \cdot S 3 ( k - i ) \\ ( {β}_{i} = ( 0.3 , 0.4 , 0.3 ) ) & [ 20 ]\end{matrix}$$

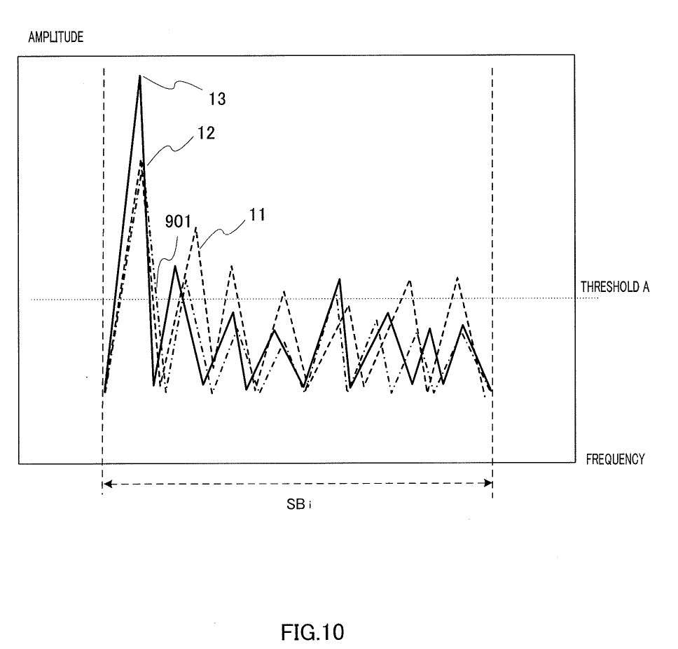

FIG. 10 shows a result of performing peak suppression processing of decoded spectrum S3(k) in peak suppression processing section 356 in a case where the value of input peak level information is 1.

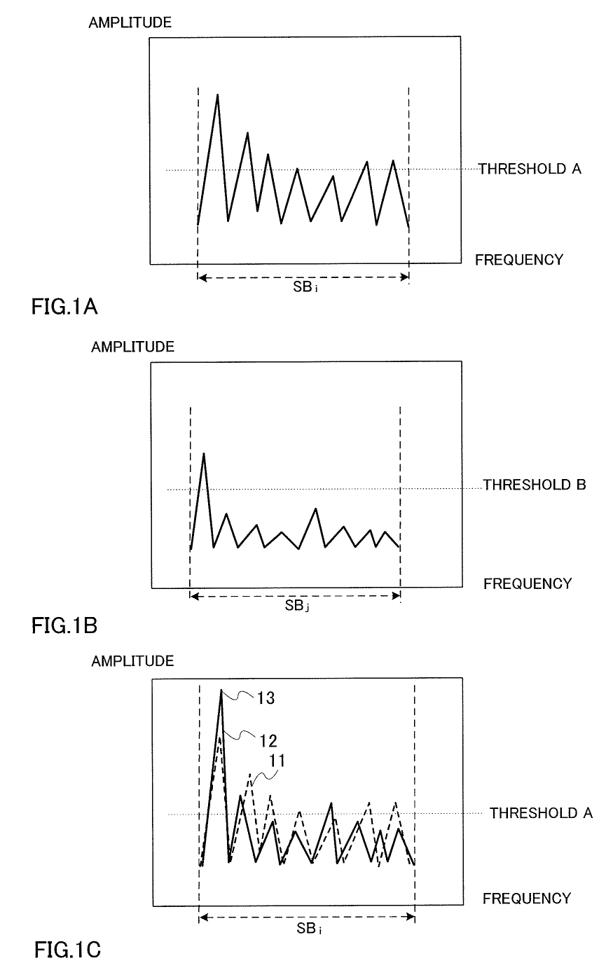

FIG. 10 shows decoded spectrum S4(k) subjected to peak suppression processing, using dotted line 901 in addition to dashed line 11, solid line 12 and peak 13 shown in FIG. 1C. As shown in FIG. 10, peaks in decoded spectrum S3(k), which are factors of abnormal sound, are suppressed by processing in peak suppression processing section 356.

Referring to FIG. 9 again, orthogonal transform processing section 357 orthogonally-transforms decoded spectrum S4(k) received as input from peak suppression processing section 356 into a time domain signal, and outputs the resulting second layer decoded signal as an output signal. Here, suitable processing such as windowing, overlapping and addition is performed where necessary, for preventing discontinuities from occurring between frames.

The specific processing in orthogonal transform processing section 357 will be explained below.

Orthogonal transform processing section 357 incorporates buffer buf′(k) and initializes it as shown in following equation 21.

[21]

buf′(k)=0 (k=0, . . . , N−1) (Equation 21)

Also, using second layer decoded spectrum S4(k) received as input from peak suppression processing section 356, orthogonal transform processing section 357 calculates second layer decoded signal y″ₙ according to following equation 22.

$$\begin{matrix}( Equation 22 ) & \\ {y}_{n}^{′′} = \frac{2}{N} {\sum }_{n = 0}^{2 N - 1} Z 5 ( k ) cos [ \frac{( 2 n + 1 + N ) ( 2 k + 1 ) π}{4 N} ] \\ ( n = 0 , … , N - 1 ) & [ 22 ]\end{matrix}$$

In equation 22, Z5(k) represents a vector combining decoded spectrum S4(k) and buffer buf′(k) as shown in following equation 23.

$$\begin{matrix}( Equation 23 ) & \\ Z 5 ( k ) = \{ \begin{matrix}{buf}^{′} ( k ) & ( k = 0 , … N - 1 ) \\ S 4 ( k ) & ( k = N , … 2 N - 1 )\end{matrix} & [ 23 ]\end{matrix}$$

Next, orthogonal transform processing section 357 updates buffer buf′(k) according to following equation 24.

[24]

buf′(k)=S4(k) (k=0, . . . , N−1) (Equation 24)

Next, orthogonal transform processing section 357 outputs decoded signal y″ₙ as an output signal.

Thus, according to the present embodiment, in coding/decoding of performing band expansion using the lower-band spectrum and estimating the higher-band spectrum, an encoding apparatus compares and analyzes the harmonic structure of the higher-band input spectrum and the harmonic structure of an estimated spectrum, and outputs the analysis result to a decoding apparatus. Also, according to this analysis result, the decoding apparatus switches between applying and not applying smoothing (blunting) processing of the estimated spectrum acquired by band expansion. That is, if the similarity between the harmonic structure of the higher-band input spectrum and the harmonic structure of the estimated spectrum is equal to or less than a predetermined level, the decoding apparatus performs smoothing processing of the estimated spectrum, so that it is possible to suppress unnatural abnormal sound included in decoded signals and improve the quality of the decoded signals.

To be more specific, if the peak level varies significantly between the higher-band input spectrum and the estimated spectrum, the decoding apparatus performs smoothing processing, so that it is possible to suppress abnormal sound, which occurs in the estimated spectrum acquired by band expansion, and improve the quality of decoded signals.

The decoding apparatus adjusts the energy of the estimated spectrum so as to be normally equal to the energy of the input signal in each subband. Consequently, for example, in a case where significant peaks equal to or greater than a predetermined level are periodically present in the higher-band spectrum of the input signal, and where, although large peaks are present in the estimated spectrum, the number of peaks equal to or greater than the predetermined level in the estimated spectrum is clearly less than in the higher-band spectrum of the input signal, a small number of peaks equal to or greater than the predetermined level in the estimated spectrum are emphasized by energy adjustment, which causes large abnormal sound. Also, the above problems can be caused even in a method of analyzing only one of the higher-band spectrum of the input signal and the estimated spectrum and applying the smoothing (blunting) processing to the estimated spectrum according to the analysis result. However, like the present embodiment, by comparing and analyzing both the harmonic structure of the higher-band spectrum of the input signal and the harmonic structure of the decoded spectrum, it is possible to suppress peaks emphasized unnaturally in the estimated spectrum, and, as a result, improve the quality of decoded signals.

Also, an example case has been described above with the present embodiment where as a method of analyzing the harmonic structure of each spectrum of peak level analyzing section 207, the number of peaks with amplitude equal to or greater than a threshold is calculated in each spectrum and peak level information is found using the difference between those numbers of peaks. However, the present invention is not limited to this, and, as a method of analyzing the harmonic structure of each spectrum, it is equally possible to find peak level information using the above ratio of peaks or the above difference of peak distribution. Also, instead of the number of peaks, it is equally possible to use, for example, the spectral flatness measure (“SFM”) of each spectrum. SFM is represented by the ratio between the geometric mean and arithmetic mean (=geometric mean/arithmetic mean) of an amplitude spectrum. SFM approaches 0.0 when the peak level of the spectrum becomes higher or approaches 1.0 when the noise level of the spectrum becomes higher. As a method of analyzing the harmonic structure, it is equally possible to compare the difference or ratio of SFM's of spectrums and find peak level information represented by the comparison result. Also, instead of SFM's, it is equally possible to calculate simple variances and find peak level information using the difference or ratio of variances.

Also, peak level analyzing section 207 may calculate the maximum amplitude value (absolute value) in each spectrum and find peak level information using a difference or ratio of these values. For example, if the difference between the maximum amplitude values of peaks in spectrums is equal to or greater than a threshold, it is possible to set the value of peak level information to 1.

Also, a method is possible where peak level analyzing section 207 provides a buffer that stores, for example, a peak size equal to or greater than a threshold and the number of peaks (hereinafter “information relating to peaks”) in the spectrum of an input signal in past frames, and where peak level analyzing section 207 compares information relating to peaks (such as the peak size and the number of peaks) in the buffer and information relating to peaks in the current frame on a per subband basis, and sets the value of peak level information to 1 if the difference or ratio of those items of information is equal to or greater than a threshold or sets the value of peak level information to 0 if the difference or ratio is less than the threshold. Also, it is possible to perform the above method of setting the value of peak level information on a per frame basis, instead of on a per subband basis.

Also, instead of comparing information relating to peaks in the current frame and information relating to peaks in past frames, it is equally possible to compare information relating to peaks in the current frame and information relating to peaks in adjacent subbands. In this case, if the difference or ratio between information relating to peaks in the current frame and information relating to peaks in adjacent subbands is equal to or greater than a threshold, by setting the value of peak level information in subbands with significant peaks or with a small number of peaks to 0, it is possible to suppress an occurrence of abnormal sound due to peak suppression processing upon band expansion.

Also, although a case has been described with the above explanation where peak level analyzing section 207 analyzes the peak level using the spectrum of an input signal, the present invention is not limited to this, and it is equally possible to analyze the peak level using a spectrum estimated in second layer encoding section 206. By analyzing the peak level using the estimated spectrum, upon determining the value of peak level information, processing of determining the value of peak level information needs to be performed only on the decoding side, and needs not be performed on the encoding apparatus side. That is, peak level information needs not be transmitted, so that it is possible to perform coding at a lower bit rate.

Also, an example case has been described above with the present embodiment where peak level information is found by analyzing the harmonic structure of the spectrum of an input signal and the harmonic structure of the spectrum of the first layer decoded signal. However, the present invention is not limited to this, and peak level analyzing section 207 can calculate the tonality (harmonic level) of an input spectrum and find peak level information according to the calculated value. For example, by setting the value of peak level information to 1 when the tonality of an input signal is equal to or greater than a threshold or setting the value of peak level information to 0 when the tonality is less than the threshold, it is possible to adaptively switch the application of suppression processing of the higher-band spectrum upon band expansion. Also, the method of setting the value of peak level information by tonality is not limited to the above method, and it is equally possible to reverse the setting values of peak level information. Tonality is disclosed in MPEG-2 AAC (ISO/IEC 13818-7), and therefore explanation will be omitted.

Also, peak level analyzing section 207 can set the value of peak level information according to the value of minimum similarity Dₘᵢₙ calculated in searching section 263. For example, peak level analyzing section 207 may set the value of peak level information to 1 when minimum similarity Dₘᵢₙ is equal to or greater than a predetermined threshold, or set the value of peak level information to 0 when minimum similarity Dₘᵢₙ is less than the threshold. By employing this configuration, if the accuracy of an estimated spectrum for the higher-band spectrum of an input signal is very low (i.e. if the similarity is low), it is possible to suppress an occurrence of abnormal sound by performing peak suppression processing of the spectrum of the target band. Also, the method of setting the value of peak level information according to minimum similarity Dₘᵢₙ is not limited to the above method, and it is equally possible to reverse the setting values of peak level information.

Also, an example case has been described above with the present embodiment where peak level analyzing section 207 uses a single threshold through the entire frame or entire subband to analyze the harmonic structure of each spectrum and determines peak level information, the present invention is not limited to this, and peak level analyzing section 207 may determine peak level information using different thresholds between frames or subbands. For example, by using a lower threshold in a higher subband, peak level analyzing section 207 can improve the effect of suppressing peaks that are present in the higher band in which the spectrum is relatively flat and that are factors of abnormal sound, so that it is possible to improve the quality of decoded signals. Also, by using different thresholds between subbands and further using a lower threshold for a sample (MDCT coefficient) in a higher band of the same subband, it is possible to switch between applying and not applying peak suppression processing more flexibly. Here, the method of setting a threshold per band is not limited to the above method, and it is equally possible to reverse the above method of setting thresholds.

Also, it is equally possible to temporally change the above threshold used in peak level analyzing section 207. For example, in a case where a relatively flat spectrum continues seamlessly over certain frames or more, by setting a lower threshold, it is possible to improve the effect of suppressing peaks that are factors of large abnormal sound. Also, it is equally possible to change this threshold on a per subband basis, instead of on a per frame basis. Also, the method of setting thresholds set on the time axis is not limited to the above method, and it is equally possible to reverse the above method of setting thresholds.

Also, it is equally possible to set the above threshold used in peak level analyzing section 207, according to a parameter acquired from first layer encoding section 202. Generally, there is a high possibility that an input signal is a voiced vowel if the value of quantization adaptive excitation gain acquired from first layer encoding section 202 is equal to or greater than a threshold, or there is a high possibility that an input signal is a voiceless consonant if the value of quantization adaptive excitation gain is less than the threshold. Therefore, for example, if a quantization adaptive excitation gain is equal to or greater than a threshold, by setting a low threshold used in peak level analyzing section 207, it is possible to emphasize suppression of abnormal sound in the voiced vowel. The method of setting thresholds using a quantization adaptive excitation gain is not limited to the above method, and it is equally possible to reverse the above method of setting thresholds. Also, it is equally possible to set a threshold used in peak level analyzing section 207, using other parameters than a quantization adaptive excitation gain.

Also, an example case has been described above with the present embodiment where a spectrum is smoothed using a multi tap, as a method of spectral peak suppression processing performed in peak suppression processing section 356. However, the present invention is not limited to this, and, for example, it is equally possible to replace part of a spectrum to be processed with a random noise spectrum, as spectral peak suppression processing. Also, for example, it is equally possible to attenuate the amplitude of a spectrum to be processed, and correct a peak value greater than a threshold to a value equal to or less than the threshold. Further, it is possible to set part of the spectrum to be processed to 0. That is, with the present invention, the method of peak suppression is not specifically limited, and it is equally possible to adopt all conventional techniques of peak suppression. Also, it is equally possible to adaptively switch the above method of peak suppression processing in peak suppression processing section 356, according to the above method of determining peak level information.

Also, an example case has been described above with the present embodiment where peak level analyzing section 207 of encoding apparatus 101 compares and analyzes the harmonic structure difference between estimated spectrum S2′(k) and the higher band FL≦k<FH of input spectrum S2(k), sends the analysis result to a decoding apparatus and switches between applying and not applying peak suppression processing in a decoding apparatus. However, the present invention is not limited to this, and it is equally possible to switch between applying and not applying peak suppression processing in the decoding apparatus, according to a search result in searching section 263. In this case, peak level information showing switching between applying and not applying peak suppression processing is found as follows. With respect to each pitch coefficient, searching section 263 calculates the similarity between the higher band FL≦k<FH of input spectrum S2(k) received as input from orthogonal transform processing section 205 and estimated spectrum S2′(k) received as input from filtering section 262, sets the value of peak level information to 0 when the similarity for optimal pitch coefficient T′ is equal to or greater than a threshold or sets the value of peak level information to 1 when the similarity is less than the threshold. That is, if the similarity between the higher band FL≦k<FH of input spectrum S2(k) and estimated spectrum S2′(k) is less than a threshold, the decoding apparatus performs smoothing processing of estimated spectrum S2′(k). By this means, it is possible to suppress a phenomenon where abnormal sound occurs by emphasizing significant peak components which are present only in estimated spectrum S2′(k). Also, in this case, peak level information is found by searching section 263, so that encoding apparatus 101 needs not provide peak level analyzing section 207.

Also, an example case has been described above with the present embodiment where encoding apparatus 101 finds peak level information per processing frame and decoding apparatus 103 switches between applying and not applying peak suppression processing, on a per frame basis, according to peak level information transmitted from encoding apparatus 101. However, the present invention is not limited to this, and encoding apparatus 101 can find peak level information per subband and decoding apparatus can switch between applying and not applying peak suppression processing on a per subband basis. By this means, it is possible to prevent phenomena where a band to which peak suppression processing is applied in a frame is limited and where sound quality degrades by applying peak suppression processing excessively and unnecessarily. Also, by limiting the subbands to which peak suppression processing is applied, it is possible to suppress peak suppression processing to a low bit rate. Here, the subband where peak level information is found may or may not employ the same configuration as a subband configuration in gain encoding section 265 and gain decoding section 354. Also, normally, in a subband of a lower frequency of the higher-band components, the peak level varies more significantly between an input spectrum and estimated spectrum. Consequently, for example, it is possible to find peak level information only in a subband of a lower frequency in the higher band and switch between applying and not applying peak suppression processing in decoding apparatus 103.

Also, an example case has been described above with the present embodiment where peak level analyzing section 207 finds peak level information according to the difference of peak levels between input spectrum S2(k) and estimated spectrum S2′(k). However, the present invention is not limited to this, and it is equally possible to find peak level information based on the difference of peak levels between the lower band and the higher band of an input spectrum. In this case, searching section 263 finds the spectrums of bands associated with pitch coefficients set in pitch coefficient setting section 264, from the lower band of the input spectrum, and peak level analyzing section 207 finds peak level information based on the difference of peak levels between the spectrums associated with pitch coefficients found in searching section 263 and the higher-band spectrum.

Also, an example case has been described above with the present embodiment where peak level information is found by analyzing the harmonic structure of the spectrum of an input signal and the harmonic structure of a first layer decoded signal. However, the present invention is not limited to this, and it is equally possible to find peak level information using a coding parameter acquired from first layer decoding section 203. For example, when first layer encoding section 202 and first layer decoding section 203 perform CELP type speech coding and CELP type speech decoding, it is possible to find a spectral envelope from quantization LPC coefficients found in first layer encoding section 202, and find energy per subband based on the found envelope. If the difference of energy in a subband or the difference of energy between subbands is equal to or greater than a threshold, an encoding apparatus sets the value of peak level information to 1. Also, it is equally possible to find peak level information using other parameters such as a quantization adaptive excitation gain, instead of quantization LPC coefficients. Generally, there is a high possibility that an input signal is the voiced vowel if the value of a quantization adaptive excitation gain is equal to or greater than a threshold, or there is a high possibility that an input signal is the voiceless consonant if the value of a quantization adaptive excitation gain is less than the threshold. Here, by setting the value of peak level information to 1 when the quantization adaptive excitation gain is equal to or greater than the threshold or setting the value of peak level information to 0 when the quantization adaptive excitation gain is less than the threshold, it is possible to adaptively switch the application of suppression processing of the higher-band spectrum upon band expansion. Also, the method of setting the value of peak level information by a quantization adaptive excitation gain is not limited to the above method, and it is equally possible to switch the setting values of peak level information. The configuration of first layer decoding section 203 that generates parameters such as quantization coefficients and quantization adaptive excitation gain and the configuration of first layer encoding section 202 that is the encoding section for first layer decoding section 203, will be explained below.

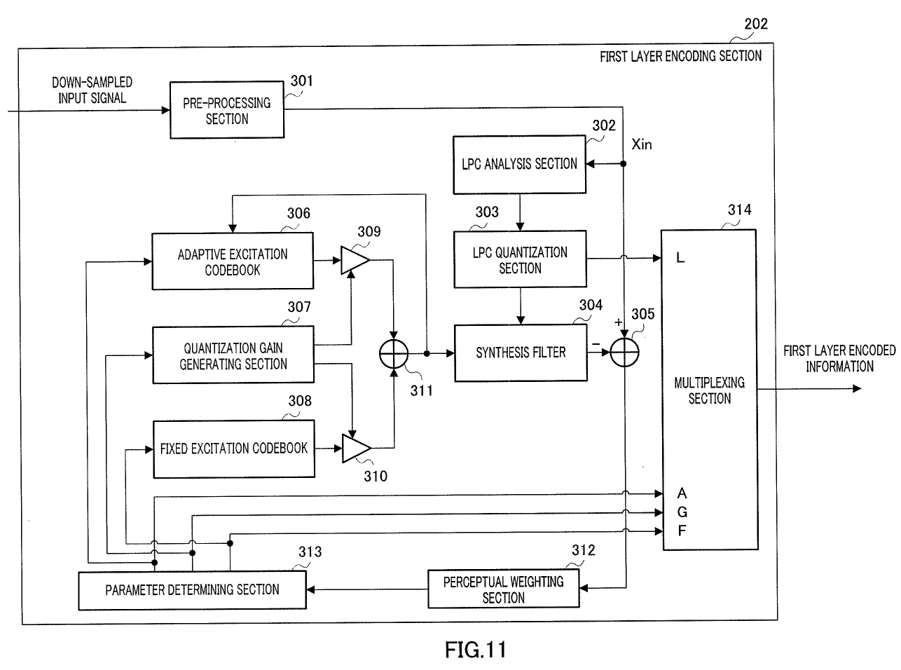

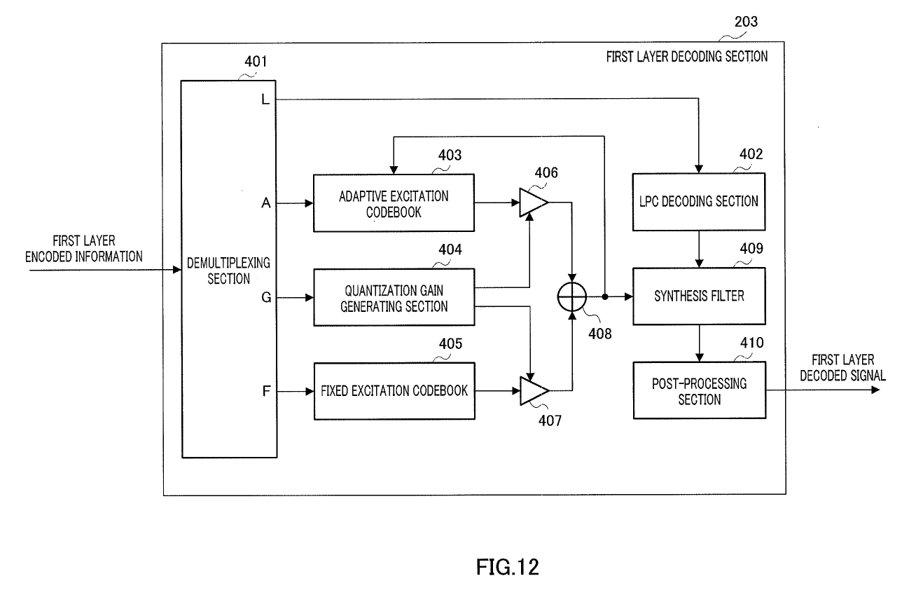

FIG. 11 and FIG. 12 are block diagrams showing the main components inside first layer encoding section 202 and first layer decoding section 203, respectively.

In FIG. 11, pre-processing section 301 performs high-pass filter processing for removing the DC component, waveform shaping processing or pre-emphasis processing for improving the performance of subsequent encoding processing, on an input signal, and outputs the signal (Xin) subjected to these processings to LPC analysis section 302 and adding section 305.

LPC analysis section 302 performs a linear predictive analysis using Xin received as input from pre-processing section 301, and outputs the analysis result (linear predictive analysis coefficient) to LPC quantization section 303.

LPC quantization section 303 performs quantization processing of the linear predictive coefficient (LPC) received as input from LPC analysis section 302, outputs the quantized LPC to synthesis filter 304 and outputs a code (L) representing the quantized LPC to multiplexing section 314.

Synthesis filter 304 generates a synthesized signal by performing a filter synthesis of an excitation received as input from adding section 311 (described later) using a filter coefficient based on the quantized LPC received as input from LPC quantization section 303, and outputs the synthesized signal to adding section 305.

Adding section 305 calculates an error signal by inverting the polarity of the synthesized signal received as input from synthesis filter 304 and adding the synthesized signal with an inverse polarity to Xin received as input from pre-processing section 301, and outputs the error signal to perceptual weighting section 312.

Adaptive excitation codebook 306 stores excitations outputted in the past from adding section 311 in a buffer, extracts one frame of samples from a past excitation specified by a signal received as input from parameter determining section 313 (described later) as an adaptive excitation vector, and outputs this vector to multiplying section 309.

Quantization gain generating section 307 outputs a quantization adaptive excitation gain and quantization fixed excitation gain specified by a signal received as input from parameter determining section 313, to multiplying section 309 and multiplying section 310, respectively.

Fixed excitation codebook 308 outputs a pulse excitation vector having a shape specified by a signal received as input from parameter determining section 313, to multiplying section 310 as a fixed excitation vector. Here, a result of multiplying the pulse excitation vector by a spreading vector can be equally outputted to multiplying section 310 as a fixed excitation vector.

Multiplying section 309 multiplies the adaptive excitation vector received as input from adaptive excitation codebook 306 by the quantization adaptive excitation gain received as input from quantization gain generating section 307, and outputs the result to adding section 311. Also, multiplying section 310 multiplies the fixed excitation vector received as input from fixed excitation codebook 308 by the quantization fixed excitation gain received as input from quantization gain generating section 307, and outputs the result to adding section 311.

Adding section 311 adds the adaptive excitation vector multiplied by the gain received as input from multiplying section 309 and the fixed excitation vector multiplied by the gain received as input from multiplying section 310, and outputs the excitation of the addition result to synthesis filter 304 and adaptive excitation codebook 306. The excitation outputted to adaptive excitation codebook 306 is stored in the buffer of adaptive excitation codebook 306.

Perceptual weighting section 312 performs perceptual weighting of the error signal received as input from adding section 305, and outputs the result to parameter determining section 313 as coding distortion.

Parameter determining section 313 selects the adaptive excitation vector, fixed excitation vector and quantization gain that minimize the coding distortion received as input from perceptual weighting section 312, from adaptive excitation codebook 306, fixed excitation codebook 308 and quantization gain generating section 307, respectively, and outputs an adaptive excitation vector code (A), fixed excitation vector code (F) and quantization gain code (G) showing the selection results, to multiplexing section 314.

Multiplexing section 314 multiplexes the code (L) showing the quantized LPC received as input from LPC quantization section 303, the adaptive excitation vector code (A), fixed excitation vector code (F) and quantization gain code (G) received as input from parameter determining section 313, and outputs the result to first layer decoding section 203 as first layer encoded information.

In FIG. 12, demultiplexing section 401 demultiplexes first layer encoded information received as input from first layer encoding section 202, into individual codes (L), (A), (G) and (F). The separated LPC code (L) is outputted to LPC decoding section 402, the separated adaptive excitation vector code (A) is outputted to adaptive excitation codebook 403, the separated quantization gain code (G) is outputted to quantization gain generating section 404 and the separated fixed excitation vector code (F) is outputted to fixed excitation codebook 405.

LPC decoding section 402 decodes the quantized LPC from the code (L) received as input from demultiplexing section 401, and outputs the decoded quantized LPC to synthesis filter 409.

Adaptive excitation codebook 403 extracts one frame of samples from a past excitation specified by the adaptive excitation vector code (A) received as input from demultiplexing section 401, as an adaptive excitation vector, and outputs the adaptive excitation vector to multiplying section 406.

Quantization gain generating section 404 decodes a quantization adaptive excitation gain and quantization fixed excitation gain specified by the quantization gain code (G) received as input from demultiplexing section 401, outputs the quantization adaptive excitation gain to multiplying section 406 and outputs the quantization fixed excitation gain to multiplying section 407.

Fixed excitation codebook 405 generates a fixed excitation vector specified by the fixed excitation vector code (F) received as input from demultiplexing section 401, and outputs the fixed excitation vector to multiplying section 407.

Multiplying section 406 multiplies the adaptive excitation vector received as input from adaptive excitation codebook 403 by the quantization adaptive excitation gain received as input from quantization gain generating section 404, and outputs the result to adding section 408. Also, multiplying section 407 multiplies the fixed excitation vector received as input from fixed excitation codebook 405 by the quantization fixed excitation gain received as input from quantization gain generating section 404, and outputs the result to adding section 408.

Adding section 408 generates an excitation by adding the adaptive excitation vector multiplied by the gain received as input from multiplying section 406 and the fixed excitation vector multiplied by the gain received as input from multiplying section 407, and outputs the excitation to synthesis filter 409 and adaptive excitation codebook 403.

Synthesis filter 409 generates a synthesized signal by performing a filter synthesis of the excitation received as input from adding section 408 using a filter coefficient based on the quantized LPC decoded in LPC decoding section 402, and outputs the synthesized signal to post-processing section 410.

Post-processing section 410 applies processing for improving the subjective quality of speech such as formant emphasis and pitch emphasis and processing for improving the subjective quality of stationary noise, to the synthesized signal received as input from synthesis filter 409, and outputs the result to up-sampling processing section 204 as a first layer decoded signal.

### Embodiment 2

An example case has been described above with Embodiment 1 where searching section 263 changes pitch coefficient T variously, calculates the similarity between the higher band FL≦k<FH of input spectrum S2(k) and estimated spectrum S2′(k), as the distance between these spectrums, and searches for optimal pitch coefficient T′ with which the distance is the longest. By contrast with this, according to Embodiment 2 of the present invention, using the distance between the higher band FL≦k<FH of input spectrum S2(k) and estimated spectrum S2′(k) as a measure for calculation, a searching section takes into account not only similarity but also the difference of peak levels between these spectrums. As a result, even in a case where the similarity between these two spectrums is the highest, if the difference of peak levels is significant, pitch coefficient T in this case is not used as optimal pitch coefficient T′, and estimated spectrum S2′(k) in this case is not used as an estimated spectrum finally selected by a search in a searching section.

The communication system (not shown) according to Embodiment 2 of the present invention is basically the same as communication system 100 shown in FIG. 2, and differs from encoding apparatus 101 of communication system 100 only in part of the configuration and operations of an encoding apparatus.

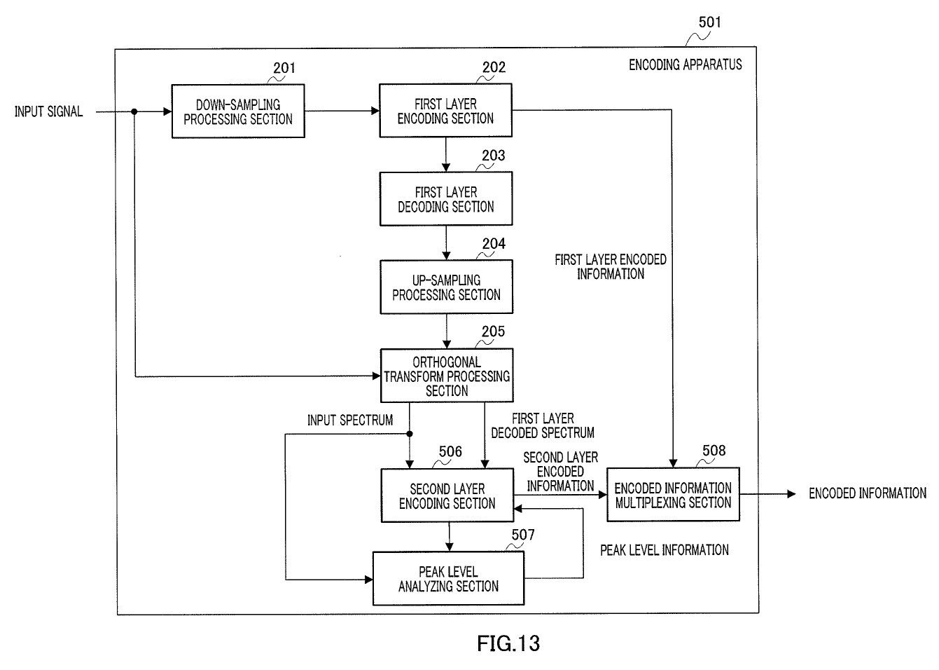

FIG. 13 is a block diagram showing the main components inside encoding apparatus 501 according to Embodiment 2 of the present invention. Also, encoding apparatus 501 is basically the same as encoding apparatus 101 shown in FIG. 3, and differs from encoding apparatus 101 in providing second layer encoding section 506, peak level analyzing section 507 and encoded information multiplexing section 508 instead of second layer encoding section 206, peak level analyzing section 207 and encoded information multiplexing section 208.

Peak level analyzing section 507 shown in FIG. 13 have basically the same configuration and operations as peak level analyzing section 207 shown in FIG. 3, and differs from peak level analyzing section 207 in outputting peak level information showing a peak level analysis result to second layer encoding section 506 instead of encoded information multiplexing section 208. Also, peak level analyzing section 507 differs from peak level analyzing section 207 in receiving as input, from second layer encoding section 506, estimated spectrum S2′(k) for each pitch coefficient T, instead of estimated spectrum S2′(k) for optimal pitch coefficient T′. Further, peak level analyzing section 507 finds peak level information PeakFlag for each pitch coefficient T, using above equations 14 to 17, and outputs the results to searching section 563 which will be described later.

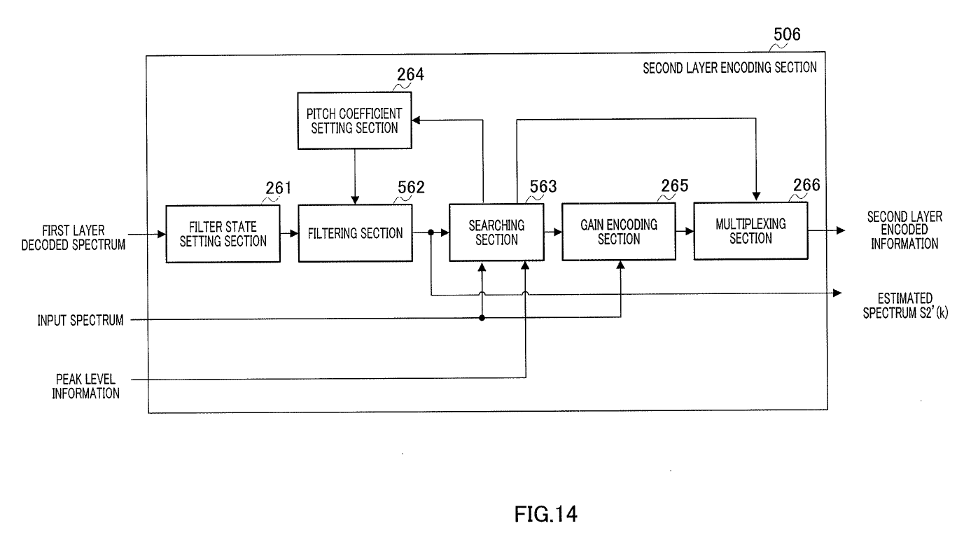

FIG. 14 is a block diagram showing the main components inside second layer encoding section 506 according to the present embodiment. In FIG. 14, explanation will be omitted for the same components as in second layer encoding section 206 shown in FIG. 4.

Filtering section 562 is basically the same as filtering section 262 shown in FIG. 4, and differs from filtering section 262 only in outputting estimated spectrum S2′(k) for each pitch coefficient T to peak level analyzing section 507 in addition to searching section 563.

Searching section 563 has basically the same configuration and operations as searching section 263 shown in FIG. 4, and differs from searching section 263 in receiving as input peak level information from peak level analyzing section 507 and not outputting estimated spectrum S2′(k) for optimal pitch coefficient T′ to peak level analyzing section 507.

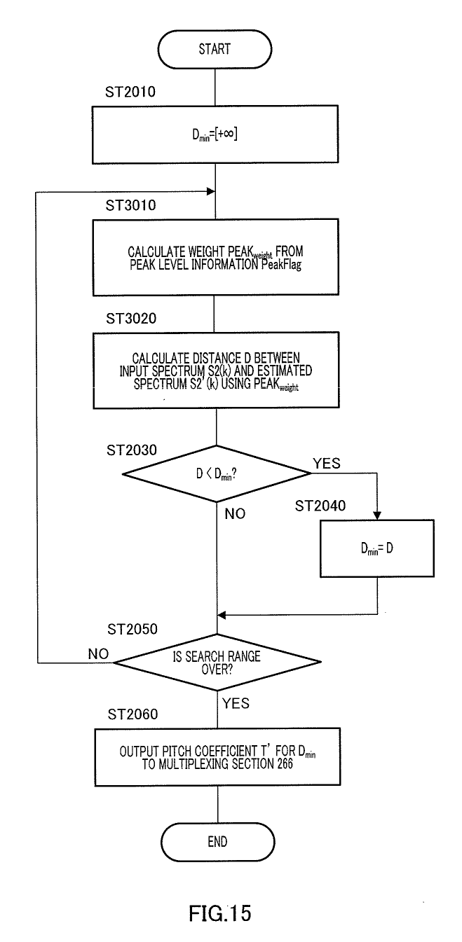

FIG. 15 is a flowchart showing the steps in the process of searching for optimal pitch coefficient T′ in searching section 563. Also, the processing steps shown in FIG. 15 differs from the processing steps shown FIG. 7 only in adding ST 3010 and replacing ST 2020 with ST 3020. Only ST 3010 and ST 3020 will be explained below.

In ST 3010, searching section 563 calculates weight PEAK_{weight} for distance calculation, based on the value of peak level information PeakFlag received as input from peak level analyzing section 507. For example, the value of PEAK_{weight} is set to 0 when the value of peak level information PeakFlag is 0, or is set to a value greater than 0 when the value of peak level information PeakFlag is 1.

Next, in ST 3020, searching section 563 calculates distance D between the higher band FL≦k<FH of input spectrum S2(k) and estimated spectrum S2′(k), according to following equation 25.

$$\begin{matrix}( Equation 25 ) & \\ D = {\sum }_{k = 0}^{M} S 2 ( k ) \cdot S 2 ( k ) - \frac{{( {\sum }_{k = 0}^{M} S 2 ( k ) \cdot S {2}^{′} ( k ) )}^{2}}{{\sum }_{k = 0}^{M} S {2}^{′} ( k ) \cdot S {2}^{′} ( k )} + {PEAK}_{weight} & [ 25 ]\end{matrix}$$

As shown in equation 25, compared to a case where the value of peak level information PeakFlag is 0, when the value of peak level information PeakFlag is 1, a larger value is set for PEAK_{weight} and makes distance D longer. That is, when the peak level varies significantly between the higher band FL≦k<FH of an input spectrum and estimated spectrum S2′(k), the distance to be calculated increases.

Also, as described above, an estimated spectrum generated in filtering section 562 corresponds to a spectrum acquired by filtering a first layer decoded spectrum. Therefore, the distance between the higher band FL≦k<FL of input spectrum S2(k) and estimated spectrum S2′(k) calculated in searching section 563 can also show the distance between the higher band FL≦k<FH of input spectrum S2(k) and the first layer decoded spectrum.

Referring back to FIG. 13, encoded information multiplexing section 508 differs from encoded information multiplexing section 208 shown in FIG. 3 in not receiving as input peak level information from peak level analyzing section 507 and in integrating first layer encoded information received as input from first layer encoding section 202 and second layer encoded information received as input from second layer encoding section 506.

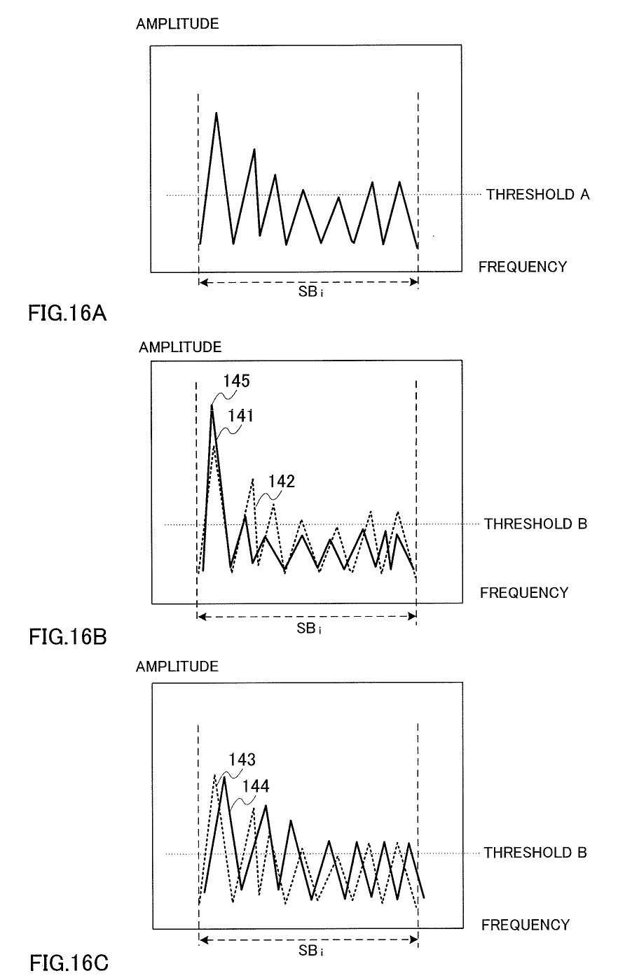

FIG. 16 illustrates an estimated spectrum to be selected in searching section 563 according to the present embodiment.

In FIG. 16, FIG. 16A exemplifies an input spectrum of subband SBᵢ in the higher band. Solid line 141 in FIG. 16B shows an example of an estimated spectrum in subband SBᵢ selected with a conventional technique. That is, the estimated spectrum shown in FIG. 16B is acquired in searching process of a conventional technique and has the highest similarity to the input spectrum shown in FIG. 16A. In FIG. 16B, the input spectrum shown in FIG. 16A is represented with dashed line 142 in an overlapping manner. FIG. 16C exemplifies an estimated spectrum in subband SBᵢ to be selected in searching section 563 according to the present embodiment. In FIG. 16C, the input spectrum shown in FIG. 16A is represented with dashed line 143 in an overlapping manner. In FIG. 16C, solid line 144 represents an estimated spectrum which is acquired according to equation 25 in searching section 563, and which minimizes distance D to the input spectrum shown in FIG. 16A.

As shown in FIG. 16B, the peak level may vary significantly between the higher-band input spectrum and the estimated spectrum, which is selected in searching process of a conventional technique and which maximizes the similarity with the higher-band input spectrum. In this case, the energy of subbands is adjusted, and, as a result, significant peak 145 that is not present in the input spectrum shown in FIG. 16A, may occur in the estimated spectrum after energy adjustment.

As shown in FIG. 16C, searching section 563 according to the present embodiment may select an estimated spectrum with peak levels closer to the peak levels of the higher-band input spectrum, instead of the most similar estimated spectrum to the higher-band input spectrum. This is because, according to equation 25, searching section 563 takes into account not only similarity but also the difference of peak levels as a measure for distance calculation between the higher-band input spectrum and the estimated spectrum. To be more specific, in equation 25, distance D is shortened when the value of peak level information is 1, and therefore an estimated spectrum with significantly different peak levels from the input spectrum is not likely to be selected. By this means, it is possible to prevent abnormal sound from occurring due to selection of an estimated spectrum with significantly different peak levels from the input spectrum, as shown in FIG. 16B

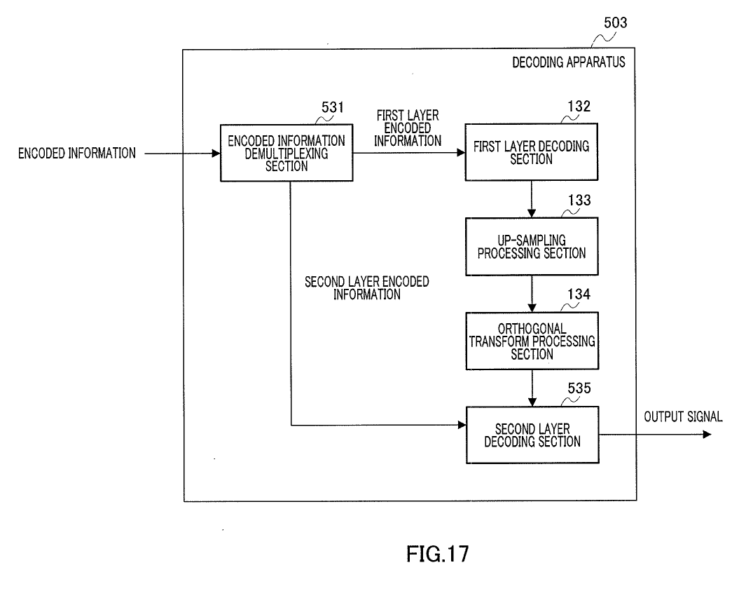

FIG. 17 is a block diagram showing the main components inside decoding apparatus 503 according to the present embodiment. Here, decoding apparatus 503 shown in FIG. 17 is basically the same as decoding apparatus 103 shown in FIG. 8, and differs from decoding apparatus 103 in providing encoded information demultiplexing section 531 and second layer decoding section 535, instead of encoding information demultiplexing section 131 and second layer decoding section 135.

In FIG. 17, encoded information demultiplexing section 531 differs from encoded information demultiplexing section 131 shown in FIG. 8 only in not providing peak level information PeakFlag in demultiplexing process. This is because peak level information PeakFlag is not transmitted from encoding apparatus 501 to decoding apparatus 503 in the present embodiment. Encoded information demultiplexing section 531 demultiplexes input encoded information into the first layer encoded information and the second layer encoded information, outputs the first layer encoded information to first layer decoding section 132 and outputs the second layer encoded information to second layer decoding section 535.

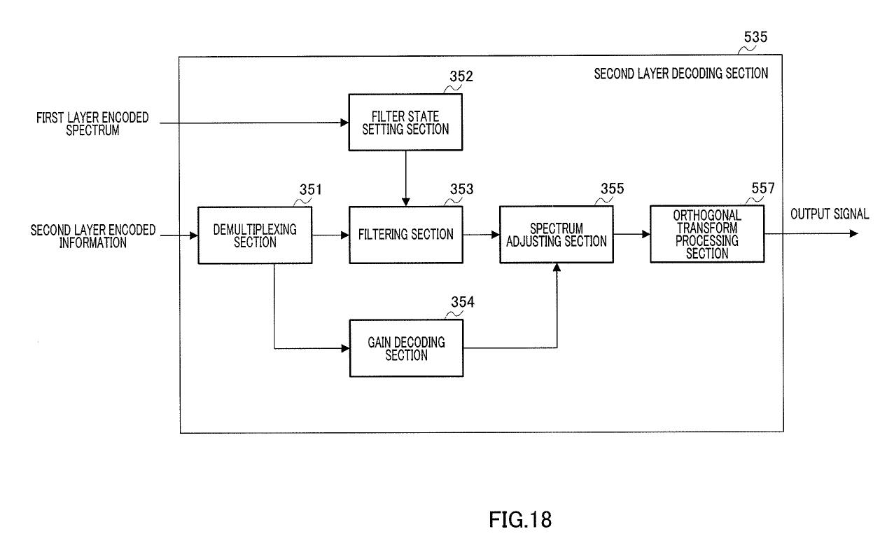

FIG. 18 is a block diagram showing the main components inside second layer decoding section 535. Here, second layer decoding section 535 differs from second layer decoding section 135 shown in FIG. 9 in not providing peak suppression processing section 356 and performing peak suppression processing. Further, second layer decoding section 535 differs from second layer decoding section 135 in providing orthogonal transform processing section 557 instead of orthogonal transform processing section 357.

Orthogonal transform processing section 557 differs from orthogonal transform processing section 357 of Embodiment 1 only in that the orthogonal transform processing target is decoded spectrum S3(k) received as input from spectrum adjusting section 355, instead of second layer decoded spectrum S4(k) received as input from peak suppression processing section 356.

Thus, according to the present embodiment, in coding/decoding of performing band expansion using the lower-band spectrum and estimating the higher-band spectrum, searching section 563 takes into account not only similarity but also the difference of peak levels as a measure for distance calculation between the higher-band input spectrum and an estimated spectrum. By this means, the decoding apparatus can avoid generating an estimated spectrum having a significantly different harmonic structure from the higher-band input signal, so that it is possible to suppress an occurrence of unnatural peaks in an estimated spectrum and improve the quality of decoded signals.

Also, as described above, according to the present embodiment, it is not necessary to search for optimal pitch coefficient T′ using peak level information in an encoding section and transmit pitch level information from the encoding apparatus to the decoding apparatus. By this means, it is possible to suppress the transmission bit rate and improve the quality of decoded signals.

Also, an example case has been described above with the present embodiment where distance calculation is performed taking into account peak levels in the entire higher-band spectrum and in the entire estimated spectrum, upon searching for optimal pitch coefficient T′ in searching section 563. However, the present invention is not limited to this, and it is equally possible to perform distance calculation taking into account peak levels only in parts of these two spectrums such as the head parts.

Embodiments of the present invention have been described above.

Also, example cases have been described with the above embodiments where decoding apparatus 103 receives as input and processes encoded data transmitted from encoding apparatus 101, it is equally possible to receive as input and process encoded data outputted from another encoding apparatus that can generate encoded data containing similar information and that has a different configuration.

Also, example cases have been described with the above embodiments where a peak level analyzing section sets the value of peak level information to 0 or 1, using the comparison of harmonic structures (peak levels) between the higher-band input spectrum and an estimated spectrum. However, the present invention is not limited to this, and it is equally possible to classify the comparison of harmonic structures in a stepwise manner and set the value of peak level information among three or more kinds of values. In this case, with the configuration of Embodiment 1, peak suppression processing section 356 needs to perform multi-tap filtering for switching between a plurality of filter coefficients according to peak level information. Further, the amplitude of a second layer decoded spectrum needs to be attenuated using a plurality of weights according to peak level information. Also, with the configuration of Embodiment 2, searching section 563 needs to perform distance calculation using a plurality of weights according to peak level information.

Also, the encoding apparatus, decoding apparatus and encoding and decoding methods according to the present invention are not limited to the above embodiments, and can be implemented with various changes. For example, it is equally possible to combine the above embodiments adequately and implement the combination.

For example, although an example case has been described above with Embodiment 2 where peak level information is not transmitted from the encoding apparatus to the decoding apparatus, the present invention is not limited to this, and it is equally possible to combine Embodiment 1 and Embodiment 2, calculate the distance between the higher-band input spectrum and an estimated spectrum taking into account the difference of peak levels, and transmit peak level information from the encoding apparatus to the decoding apparatus. For example, with the configuration explained in Embodiment 2, in a case where the distance between the higher-band input spectrum and an estimated spectrum is calculated taking into account the difference of peak levels and where the peak levels of these two spectrums are significant when that distance is minimum, it is equally possible to transmit peak level information from the encoding apparatus to the decoding apparatus and perform peak suppression processing with the same configuration as the decoding apparatus of Embodiment 1. By this means, it is possible to further improve the quality of decoded signals.

Also, the threshold, the level and the frequency used for comparison may be a fixed value or a variable value set adequately with conditions, that is, an essential requirement is that their values are set before comparison is performed.

Also, although the decoding apparatus according to the above embodiments perform processing using bit streams transmitted from the encoding apparatus according the above embodiments, the present invention is not limited to this, and it is equally possible to perform processing with bit streams that are not transmitted from the encoding apparatus according to the above embodiments as long as these bit streams include essential parameters and data.

Also, the present invention is applicable even to a case where a signal processing program is operated after being recorded or written in a computer-readable recording medium such as a memory, disk, tape, CD, and DVD, so that it is possible to provide operations and effects similar to those of the present embodiment.

Although cases have been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2007-337239, filed on Dec. 27, 2007, and Japanese Patent Application No. 2008-135580, filed on May 23, 2008, including the specifications, drawings and abstracts, are incorporated herein by reference in their entireties.

### INDUSTRIAL APPLICABILITY

The encoding apparatus, decoding apparatus and encoding method according to the present invention can improve the quality of decoded signals upon performing band expansion using the lower-band spectrum and estimating the higher-band spectrum, and are applicable to, for example, a packet communication system, mobile communication system, and so on.

1. An encoding apparatus comprising:
a first encoding section that encodes a lower band part of an input signal equal to or lower than a predetermined frequency and generates first encoded information;
a decoding section that decodes the first encoded information and generates a decoded signal;
a second encoding section that estimates a higher band part of the input signal higher than the frequency from the decoded signal to generate an estimation signal, and generates second encoded information relating to the estimation signal; and
an analyzing section that finds a difference of a harmonic structure between the higher band part of the input signal and one of the estimation signal and the lower band part of the input signal.

2. The encoding apparatus according to claim 1, wherein:
the second encoding section comprises:
a filtering section that filters the decoded signal and generates the estimation signal;
a setting section that changes and sets a pitch coefficient used in the filtering section in a predetermined range;
a searching section that searches for a pitch coefficient which maximizes a similarity between the higher band part of the input signal and the one of the lower band part of the input signal and the estimation signal, as an optimal pitch coefficient; and
a gain encoding section that finds and encodes a gain of the input signal; and
the analyzing section finds the difference of the harmonic structure between the higher band part of the input signal and the one of the lower band part of the input signal and the estimation signal associated with the optimal pitch coefficient.

3. The encoding apparatus according to claim 1, wherein:
the second encoding section comprises:
a filtering section that filters the decoded signal and generates the estimation signal;
a setting section that changes and sets a pitch coefficient used in the filtering section in a predetermined range;
a searching section that searches for a pitch coefficient which maximizes a similarity between the higher band part of the input signal and the one of the lower band part of the input signal and the estimation signal, as an optimal pitch coefficient; and
a gain encoding section that finds and encodes a gain of the input signal; and
the searching section weights the similarity using the difference of the harmonic structure and searches for the optimal pitch coefficient.

4. The encoding apparatus according to claim 1, wherein the analyzing section finds a ratio or difference of peaks with an amplitude equal to or higher than a threshold between the higher band part of the input signal and the one of the lower band part of the input signal and the estimation signal, as the difference of the harmonic structure.

5. The encoding apparatus according to claim 1, wherein the analyzing section finds a ratio or difference of spectral peak levels between the higher band part of the input signal and the one of the lower band part of the input signal and the estimation signal, as the difference of the harmonic structure.

6. The encoding apparatus according to claim 1, wherein the analyzing section finds a difference of distribution of peaks with an amplitude equal to or higher than a threshold between the higher band part of the input signal and the one of the lower band part of the input signal and the estimation signal, as the difference of the harmonic structure.

7. The encoding apparatus according to claim 1, wherein the analyzing section finds a difference of spectral flatness measures or variances between the higher band part of the input signal and the one of the lower band part of the input signal and the estimation signal, as the difference of the harmonic structure.

8. A decoding apparatus comprising:
a receiving section that receives first encoded information, second encoded information and a difference of a harmonic structure, the first encoded information encoding a lower band part of an input signal equal to or lower than a predetermined frequency in an encoding apparatus, the second encoded information being for estimating a higher band part of the input signal higher than the frequency from a first decoded signal acquired by decoding the first encoded information, and the difference of the harmonic structure being provided between the higher band part of the input signal and one of a first estimation signal estimated from the first decoded signal and the lower band part of the input signal;
a first decoding section that decodes the first encoded information and provides a second decoded signal; and
a second decoding section that generates a second estimation signal by estimating the higher band part of the input signal from the second decoded signal using the second encoded information, generates a third decoded signal by performing peak suppression processing of the second estimation signal when the difference of the harmonic structure is equal to or greater than a threshold, and uses the second estimation signal as is as the third decoded signal when the difference of the harmonic structure is less than the threshold.

9. The decoding apparatus according to claim 8, wherein the second decoding section comprises:
a filtering section that filters the second decoded signal using a pitch coefficient included in the second encoded information and generates the second estimation signal;
an adjusting section that adjusts an energy of the second estimation signal using gain information included in the second encoded information and generates an adjusted signal; and
a peak suppression processing section that performs the peak suppression processing of the adjusted signal when the difference of the harmonic structure is equal to or greater than a predetermined level.

10. The decoding apparatus according to claim 9, wherein the peak suppression processing section performs one of smoothing processing, gain attenuation processing and replacement processing using a noise signal, as the peak suppression processing for the second estimation signal.

11. An encoding method comprising the steps of:
encoding a lower band part of an input signal equal to or lower than a predetermined frequency and generating first encoded information;
decoding the first encoded information and generating a decoded signal;
estimating a higher band part of the input signal greater than the frequency from the decoded signal to generate an estimation signal, and generating second encoded information relating to the estimation signal; and
finding a difference of a harmonic structure between the higher band part of the input signal and one of the estimation signal and the lower band part of the input signal.

12. A decoding method comprising:
receiving first encoded information, second encoded information and a difference of a harmonic structure, the first encoded information encoding a lower band part of an input signal equal to or lower than a predetermined frequency in an encoding apparatus, the second encoded information being for estimating a higher band part of the input signal higher than the frequency from a first decoded signal acquired by decoding the first encoded information, and the difference of the harmonic structure being provided between the higher band part of the input signal and one of a first estimation signal estimated from the first decoded signal and the lower band part of the input signal;
decoding the first encoded information and generating a second decoded signal; and
generating a second estimation signal by estimating the higher band part of the input signal from the second decoded signal using the second encoded information, generating a third decoded signal by performing peak suppression processing of the second estimation signal when the difference of the harmonic structure is equal to or greater than a threshold, and using the second estimation signal as is as the third decoded signal when the difference of the harmonic structure is less than the threshold.
